(19) United States
(12) Patent Application Publication
(10) Pub. No.: US 2009/0316053 A1
(43) Pub. Date: Dec. 24, 2009

(54) MOBILE DIGITAL TELEVISION DEMODULATION CIRCUIT AND METHOD

(75) Inventors: Feng Huang, Hoffman Estates, IL (US); Azzedine Touzni, Algonquin, IL (US); Xiaoqiang Ma, Streamwood, IL (US)

Correspondence Address: ADVANCED MICRO DEVICES, INC.;C/O VEDDER PRICE P.C., 222 N.LASALLE STREET, CHICAGO, IL, 60601, US

(73) Assignee: Advanced Micro Devices, Inc., Sunnyvale, CA (US)

(21) Appl. No.: 12/141,504

(22) Filed: Jun. 18, 2008

(51) Int. Cl. H04N 5/455

(52) U.S. Cl. 348/726; 348/E05.113

(57) ABSTRACT

Pilot processing logic, depending upon which modulation scheme of wireless digital mobile television signals is being received, produces both fractional frequency offset and fractional timing offset for symbols for a respective modulation scheme whether the modulation scheme employs pilot or non-pilot information. As such, in operation, the pilot processing logic will produce both fractional frequency offset and fractional timing offset for symbols from different modulation schemes that employ pilot or non-pilot information so that multiple different modulation schemes of wireless digital mobile television signals can be received by a mobile device, for example, that employs the mobile television demodulating circuit. A dual operation circuit selects the mode of operation, namely the modulation scheme (e.g., T-DMB or DVB-T) of the digital mobile television signal that is being received.

### BACKGROUND OF THE INVENTION

The invention relates generally to apparatus and methods for processing digital mobile television broadcast information.

There are multiple digital television standards or digital broadcast standards such as DVB-H (Digital Video Broadcasting for Terrestrial) and T-DMB (Terrestrial Digital Multimedia Broadcasting). Both standards use orthogonal frequency division multiplexing (OFDM) as the transmission technique but use different modulation schemes. OFDM systems are often utilized to help defeat frequency selective multi-path channel interference. When recovering a signal in a receiver, the receiver employs an equalizer, frame synchronization, timing recovery, frequency recovery circuits and error correction circuits as known in the art. However, OFDM systems can be very sensitive to timing and frequency synchronization offsets, such as the synchronization of Fast Fourier Transform (FFT) circuits to operate on a correct frequency block.

As known, a Digital Video Broadcasting (DVB) modulation scheme may use pilot information by using distributed pilot signal information. However, T-DMB modulation schemes generate frame information that is different from a DVB frame information. It would be desirable to have an integrated circuit for both T-DMB and DVB frame, timing and frequency synchronization.

FIG. 1 illustrates one example of a T-DMB transmission frame. A transmission frame may include, for example, a null symbol 100, a phase reference symbol 102, a fast information symbol 104 and a main service symbol 106. A frame is a collection of symbols and each symbol may be, for example, a segment of samples. A symbol may be, for example, 2048 samples, or any other suitable size. The null symbol and phase reference symbols are used for frame, frequency, and symbol synchronization. The fast information channel (FIC) symbol is a channel that contains multiplex reconfiguration information, service component information and traffic information. The main service channel symbol carries the audio and video streams and occupies a major part of the transmission frame. However, in a DVB-T frame, there is no null symbol and no phase reference symbol.

Some known frequency and timing tracking techniques may use continuous pilots in two consecutive OFDM symbols. However, such schemes cannot typically be directly used in T-DMB systems that do not employ pilot symbols.

In DVB systems, fractional frequency offset is corrected based on a result of a slope applied to OFDM samples. However, there can be large performance degradation when the technique is employed in a dispersive channel system. In other current T-DMB systems, there is no fractional sampling clock offset tracking utilized. With OFDM communication systems that do not employ pilot information, it has been proposed to estimate the fractional frequency offset with feedback information from a demodulation module. A technique to estimate the fractional frequency offset and fractional timing offset with feedback from a forward error correction module or an output of a Veterbi coder also has been proposed. The fractional frequency offset and fractional timing offset are typically provided in the frequency domain to an interpolator to synchronize received symbols. Such techniques have advantage when there are not enough assist pilots available. However, these are proposed for pilot information based modulation schemes such as DVB systems.

In addition, in a T-DMB transmission frame, the data in the Fast Information Channel (FIC) are protected with a ⅓ rate convolution code and no time interleaving as employed before transmission. The data in the main service channel could be coded with various convolution codes and a time interleaver may be required before passing it to a transmission module. The time interleaver used in a T-DMB system however is an in-depth interleaver with a depth of 16 frames. If the forward error correction feedback information placed in the MSC symbol are used, a 16 frame in-depth interleaver would need to be employed but also a large delay would also be introduced which would be undesirable.

The techniques that attempt to estimate fractional frequency offset with feedback from a demodulation module may utilize data that has interleaver samples so large memories may be required to store the symbols. Also, a known technique attempts to create pilot information by using feedback from a decoder after an error correction block but can become complex and would require large memory to store the symbols. Another technique applies feedback before error correction but this can introduce too much error.

As such, an improved demodulating circuit that would accommodate a different modulating schemes of wireless digital mobile television signals would be desirable.

### BRIEF DESCRIPTION OF THE DRAWINGS

The invention will be more readily understood in view of the following description when accompanied by the below figures and wherein like reference numerals represent like elements, wherein:

FIG. 1 is a diagram illustrating one example of a transmission frame of a T-DMB transmission frame;

FIG. 2 is a block diagram illustrating one example of a mobile device employing one example of a mobile television demodulating circuit in accordance with one example;

FIG. 3 is a flowchart illustrating one example of a method of demodulating that may be carried out, for example, by the circuitry of FIG. 2;

FIG. 4 is a block diagram illustrating one example of mobile television demodulating circuit in accordance with one example; and

FIG. 5 illustrates one example of a mobile device employing a mobile television demodulating circuit of FIG. 4.

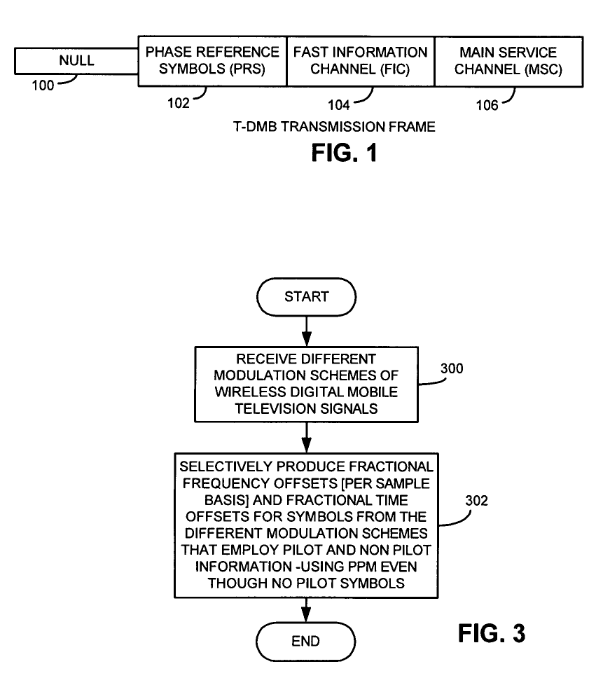

### DETAILED DESCRIPTION OF THE PREFERRED EMBODIMENTS

Briefly, pilot processing logic, depending upon which modulation scheme of wireless digital mobile television signals is being received, produces both fractional frequency offset and fractional timing offset for symbols for a respective modulation scheme whether the modulation scheme employs pilot or non-pilot information. As such, in operation, the pilot processing logic will produce both fractional frequency offset and fractional timing offset for symbols from different modulation schemes that employ pilot or non-pilot information so that multiple different modulation schemes of wireless digital mobile television signals can be received by a mobile device, for example, that employs the mobile television demodulating circuit. A dual operation circuit selects the mode of operation, namely the modulation scheme (e.g., T-DMB or DVB-T) of the digital mobile television signal that is being received. For example, when in a T-DMB mode, the circuit utilizes a controllable data symbol selector that is coupled to the pilot processing logic and provides pre-error corrected data symbols and fast information channel (FIC) error correction data symbols based on modulation scheme selection information such as whether the mode is the T-DMB mode or DVB mode. For example, when in the DVB mode, the controllable data symbol selector does not provide pre-error corrected data symbols and FIC error correction data symbols but instead passes pilot information from an equalizer to the pilot processing logic. Among other advantages, pilot processing logic is shared for multiple modulation scheme operation and symbols are split so only certain types of symbols are fed back to the pilot processing logic depending upon the mode of the circuit. The fast information channel symbols are fed back after error correction and data symbols are fed back prior to error correction during a T-DMB mode of operation.

Both DVB-T and T-DMB mode use previous symbol and current symbols. T-DMB operation creates pilots by feeding back while DVB-T utilizes the continuous pilots inserted into every symbol directly.

The pilot processing logic is also operative to use preamble data from an equalizer stage in response to modulation scheme selection information, such as when the modulation scheme selection information indicates that the circuit is to operate in a DVB-T mode. The demodulating circuit also includes logic that produces demodulated transport stream that contains data for display on a video display device.

In one example, a mobile television demodulating circuit includes a down converter stage that receives an incoming signal from an antenna that is modulated in one of a plurality of different modulation schemes, such as a T-DMB modulation scheme or a DVB modulation scheme. The down converter down converts wireless digital mobile television signals communicated via either of the different modulation schemes to a respective baseband signal. An interpolator produces sample rate control information for a FFT stage based on the baseband signal. The FFT stage produces frequency domain symbol information for an equalizer stage that is operative to produce equalized symbol information based on the frequency domain symbol information. A demapper stage provides pre-error corrected data symbols from the equalizer and an error correction stage corrects errors in the pre-error corrected data symbols to produce fast information channel error correction data symbols. A controllable data symbol selector outputs pre-error corrected data symbols and FIC error correction data symbols for the pilot processing logic, based on modulation scheme selection information, such as when the circuit is selected to process T-DMB information. The pilot processing logic produces fractional frequency offset on a per-symbol basis and fractional timing offset on a per-symbol basis for symbols via either fed back preamble data such as in the case when the circuit is operating in a DVB-T mode, or fractional frequency offset and fractional timing offset using both FIC post error correction and pre-error correction data symbols in the T-DMB mode. The demodulating circuit also includes, in one example, an interpolator that is operative to use the fractional frequency offset and fractional timing offset generated by the pilot processing logic to correct the sampling rate and the slope caused by fractional frequency offset before the FFT stage. Synchronization logic includes an acquisition stage to generate FFT trigger position information for the FFT stage and also generates initial fractional frequency offset information.

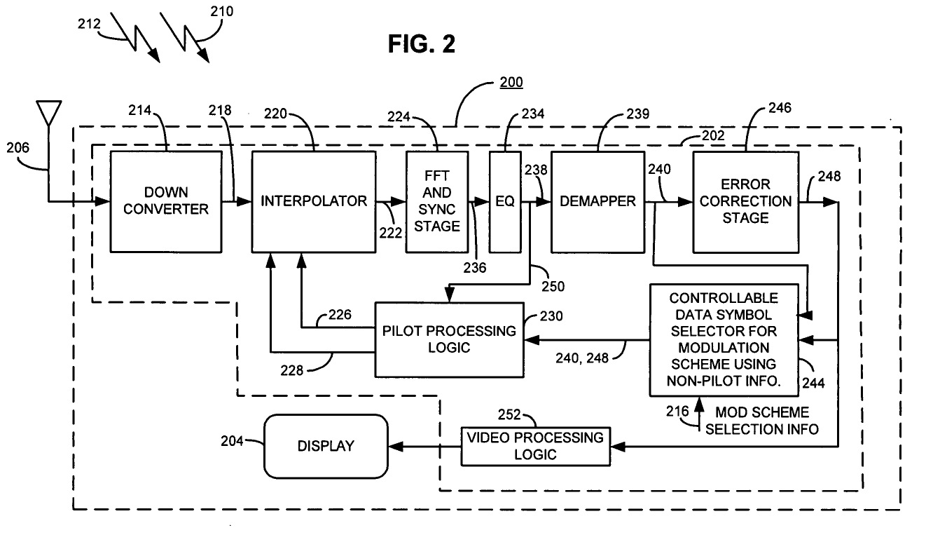

FIG. 2 illustrates one example of a mobile device 200 that incorporates a mobile television demodulating circuit 202 that is operatively coupled to a display 204 that displays output from one or more digital transport streams received, by way of example via antenna 206. The mobile device 200 may be any suitable device including, but not limited to, a laptop computer, handheld cell phone with television signal processing, or any other suitable device. In this example, the mobile television demodulating circuit 202 can process wireless digital mobile television signals 210 that are communicated via a modulation scheme such as T-DMB, or can also process wireless digital mobile television signals 212 that are modulated via a different modulation scheme such as DVB. Both schemes in this example use orthogonal frequency division multiplexing. For purposes of facilitating explanation, the functional blocks shown herein are general examples and do not include all of the conventional circuitry as known in the art. It will be recognized that known circuits may be employed for various functional blocks shown unless otherwise described herein. It will also be recognized that the various functions may be divided or grouped among other functions as desired.

The mobile television demodulating circuit 202, in this example, operates in one of two modes however any suitable number of modes may be employed if desired. The modes are selected by modulation scheme selection information 216 which may be provided, for example, by a user through a user interface or may be set by a manufacturer or may be automatically set when the device enters a region which communicates a specific type of mobile television signaling scheme. In this example, the two modes are a T-DMB mode and a DVB-T mode. The mobile television demodulating circuit 202 utilizes the down converter to down convert wireless digital mobile television signals that are communicated via the different modulation schemes depending upon the modulation scheme selection information and down converts the received signal to the respective baseband signal 218. The interpolator as known in the art 220 receives the baseband signal 218 and produces sample rate control information 222 for a fast Fourier transform (FFT) and synchronization stage 224. The interpolator is also operatively responsive to fractional frequency offset information 226 and fractional timing offset information 228 for example on a per-symbol basis for symbols as produced by pilot processing logic 230.

The FFT stage produces frequency domain symbol information 236 for an equalizer stage 234 and the equalizer stage 234 produces equalized symbol information 238 also referred to as equalized symbol information. A demapper stage provides pre-error corrected data symbols 240 that have been demapped as known in the art. The demapper 239 provides the pre-error corrected data symbols 240 to a controllable data symbol selector 244 and to an error correction stage 246. The error correction stage 246 corrects errors in the pre-error corrected data symbols 240 and produces the Fast Information Channel (FIC) error corrected data symbols 248 and are received by the controllable data symbol selector 244. The FIC error corrected data symbols 248 are configuration information used by video processing logic 252. The controllable data symbol selector 244 is operative to output pre-error corrected data symbols 240 and FIC error correction data 248 for the pilot processing logic 230 based on the modulation scheme selection information 216. Buffer 430 in pilot process module 230 is used to save previous preamble pilot symbol data 250 for DVB or feedback data 240 and 248 for T-DMB. The pilot process module 230 generates fractional frequency offset 226 and fractional timing offset 228 from saved previous preamble pilot symbol data and current preamble pilot symbol data for DVB or from saved feedback data and current feedback data for T-DMB operation.

For example, if the modulation scheme selection information 216 indicates that the modulation mode is the T-DMB mode, the information, namely the pre-error corrected data symbols and the FIC error correction data symbols 240 and 248 are passed to the pilot processing logic 230. These feedback data are equivalent to preamble pilots in the DVB modulation scheme since there is no pilot information in the T-DMB. However, if the modulation scheme selection information 216 indicates that the circuit is in the DVB-T mode, no data is passed by the controllable data symbol selector 244 to the pilot processing logic. Instead, the pilot processing logic 230 utilizes equalized symbol information 250 output by the equalizer 234 as described further below. The pilot processing logic 230 produces the fractional frequency offset information 226 and fractional timing offset information 228 for symbols based on either the preamble pilot data 250 when the modulation circuit is in the DVB-T mode, or produces the fractional frequency offset information 226 and fractional timing offset information 228 based on feedback from both the FIC post-error correction symbols and pre-error correction data symbols 248 and 240 respectively when the modulation circuit is in the T-DMB mode.

The interpolator 220 is operative to use the fractional frequency offsets and fractional timing offset information from the pilot processing logic to correct the sampling rate to get accurate samples for the FFT stage 224. As such, the pilot processing logic 230 is operative to use preamble pilot data 250 from the equalizer stage to generate the fractional frequency offset and fractional timing offset when in the DVB-T mode based on the modulation scheme selection information 216 or alternatively, utilizes the output from the controllable data symbol selector 244 to produce the fractional frequency offset information and fractional timing offset information 226 and 228 when in the T-DMB mode.

The various functions may be implemented in any suitable manner including, for example, logic circuitry, programmable processors that execute code that is stored in memory (e.g., RAM, ROM, etc.) and may be integrated on an integrated circuit. In addition, the functional blocks may be integrated on more than one integrated circuit depending upon the desired design configuration.

FIG. 3 illustrates a method of operation of the modulation circuit 202. As shown in block 300, the method includes receiving different modulation schemes of wireless digital mobile television signals 212 and 210 via, for example, the antenna. These different modulation schemes are not typically received at the same time since the modulation circuit 202 is typically set to operate in a particular mode namely DVB mode or T-DMB mode. As such, receiving the different modulation schemes occurs over different points of time.

As shown in block 302, the method includes selectively producing fractional frequency offset and fractional timing offset 226 and 228 for symbols based on the different modulation schemes. One modulation scheme may employ, for example, pilot information, such as the DVB-T modulation scheme, and another modulation scheme such as the T-DMB mode is a non-pilot information based modulation scheme. However, the circuit 202 selectively produces fractional frequency offsets and fractional timing offsets for both modulation schemes depending upon the selected mode of operation.

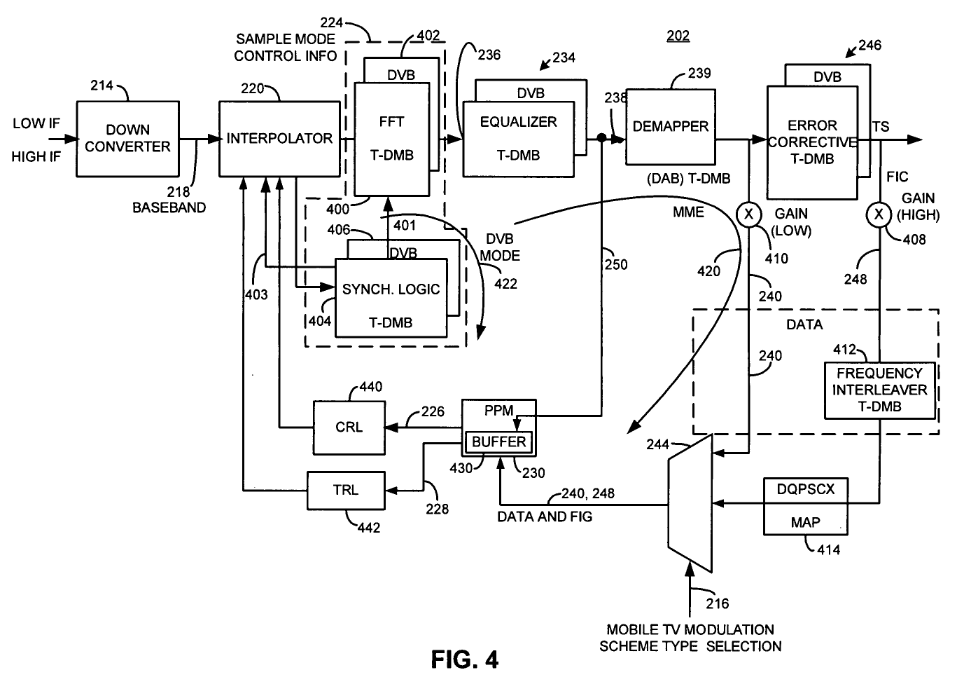

FIG. 4 shows in more detail an example of the wireless digital mobile television signal demodulation circuit 202. As shown in this example, various functional blocks include separate functional operations if desired for the different modes of operation. For example, the FFT and sync stage 224 may include an FFT circuit for the T-DMB mode and another FFT circuit 402 for the DVB mode and similarly synchronization logic 404 for a T-DMB mode and similar synchronization logic for DVB mode 406 may be employed. The synchronization logic 404 produces FFT trigger position information 401 and initial fractional frequency offset information 403 for the interpolator 220. The structure of these circuits is known in the differing arts of T-DMB receivers and DVB receivers combined in this implementation in a common circuit. Likewise, different equalizer circuits may be employed where the same equalizer circuit that is programmable may be employed for the differing modes of operation as well as the error correction blocks.

As also shown, the modulation circuit 202 may include gain stages 408 in the FIC symbol path and a gain stage in the pre-error correction data symbol path shown as 410. The gain stage 410 may be a low gain stage and the gain stage 408 may be a high gain stage for example. The FIC post-error correction information may be frequency interleaved in the T-DMB mode by frequency interleaver 412 and the symbols may then be passed through a DQPSK map 414 as known in the art. The controllable data symbol selector 216 outputs both symbols input thereto when the mobile television modulation scheme selection information 216 indicates that the circuit should be operating in a T-DMB mode. The outline 420 generally indicates that in the T-DMB mode, the demapper and FIC error correction data symbols and the pre-error correction data symbols 240 are employed. The arc line 422 illustrates that during the DVB-T mode, the preamble data 250 is employed and stored, for example, in a buffer 430 to be compared with current symbol information as known in the art in decoding DVB-T symbols.

The pilot processing logic 230 outputs the fractional frequency offset information 226 to a carrier recovery loop (CRL) block which is a loop filter to generate filtered frequency offset 440 and the fractional timing offset information 228 is provided to a timing recovery loop (TRL) which is a loop filter to generated filtered timing offset 442. As such, the pilot processing logic is responsive to different modulation schemes of wireless digital mobile television signals such as one that includes pilot information and symbols for synchronization and another modulation scheme that does not include such pilot symbols. The pilot processing logic 230 produces both fractional frequency offset information 226 on a per-symbol basis and fractional timing offset for symbols 228 from the different modulation schemes when in different modes of operation. The pilot processing logic 230 uses the preamble data 250 from the equalizer stage when in DVB-T mode of operation.

As such, among other advantages, the mobile television demodulating circuit 202 utilize shared pilot processing logic 230 and selectively provides FIC symbols and pre-error correction data symbols only for the demodulation of wireless digital mobile television signal schemes that do not employ pilot information in the symbols. As such, a multimode demodulator circuit may be utilized in mobile devices that can accommodate differing wireless digital mobile television signals. Other advantages will be recognized by those of ordinary skill in the art.

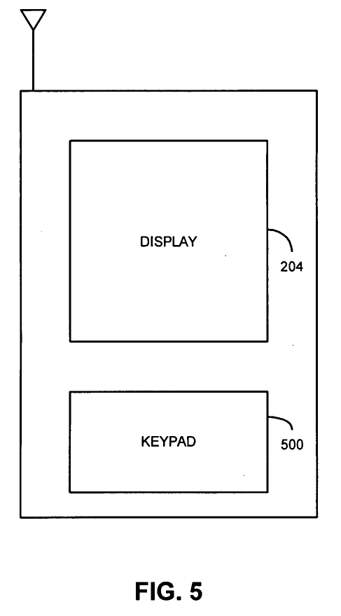

FIG. 5 is one example of a mobile handheld device with a suitable keypad 500 and display 204 wherein the device of FIG. 5 employs the circuit of FIGS. 2 and 4.

The above detailed description of the invention and the examples described therein have been presented for the purposes of illustration and description only and not by limitation. It is therefore contemplated that the present invention cover any and all modifications, variations or equivalents that fall within the spirit and scope of the basic underlying principles disclosed above and claimed herein.

What is claimed is:

1. A mobile television demodulating circuit comprising:
pilot processing logic operatively responsive to different modulation schemes of wireless digital mobile television signals and operative to produce both fractional frequency offset and fractional timing offset for symbols from the different modulation schemes that employ pilot and non pilot information.

2. The demodulating circuit of claim 1 comprising a controllable data symbol selector, operatively coupled to the pilot processing logic, and operative to provide pre-error corrected data symbols and FIC error correction data symbols based on modulation scheme selection information.

3. The demodulating circuit of claim 1 wherein the pilot processing logic is operative to use preamble data from an equalizer stage in response to modulation scheme selection information.

4. The demodulating circuit of claim 1 comprising logic operative to produce a demodulated transport stream containing data for display on a video display device.

5. A mobile device comprising the demodulation circuit of claim 1.

6. A mobile television demodulating circuit comprising:
a down converter stage operative to down convert wireless digital mobile television signals communicated via different modulation schemes to a respective baseband signal;
an interpolator operatively responsive to the respective baseband signal and operative to produce sample rate control information for an FFT stage;
the FFT stage operative to produce frequency domain symbol information from the baseband signal;
an equalizer stage operative to produce equalized symbol information based on the frequency domain symbol information;
a demapper stage operative to provide pre-error corrected data symbols;
an error correction stage operative to error correct the pre-error corrected data symbols and produce FIC error correction data symbols; and
a controllable data symbol selector, operatively coupled to pilot processing logic, and operative to output pre-error corrected data symbols and FIC error correction data symbols for the pilot processing logic, based on modulation scheme selection information,
the pilot processing logic, operatively coupled to the equalizer and operative to produce fractional frequency offsets and fractional timing offsets for symbols via either preamble data or feedback of both FIC post error correction and pre error correction data symbols; and
wherein the interpolator is operative to use the fractional frequency offset and fractional timing offsets to correct a sample rate and slope caused by fractional frequency offset for the FFT stage.

7. The demodulating circuit of claim 6 wherein the pilot processing logic is operative to use preamble data from an equalizer stage in response to modulation scheme selection information.

8. A mobile device comprising the demodulation circuit of claim 6.

9. An integrated circuit comprising the demodulation circuit of claim 6.

10. A method comprising:
receiving different modulation schemes of wireless digital mobile television signals; and
selectively producing fractional frequency offset and fractional timing offset for symbols from the different modulation schemes that employ pilot and non pilot information.

11. The method of claim 10 comprising selectively producing fractional frequency offset and fractional timing offset for symbols for a modulation scheme that employ non-pilot information in response to modulation scheme selection information by feeding back pre-error corrected data symbols and FIC error correction data symbols based on the modulation scheme selection information.

12. The method of claim 11 comprising:
down converting wireless digital mobile television signals communicated via different modulation schemes to a respective baseband signal;
producing sample rate control information for an FFT stage based on the fractional frequency offset and fractional timing offset; and
using the fractional frequency offset and fractional timing offset to correct a sample rate and slope caused by fractional frequency offset for the FFT stage; and
generating an output transport stream containing data based on output from the FFT stage for display on a mobile television display.
